(19) United States
(12) Patent Application Publication
(10) Pub. No.: US 2003/0182097 A1
(43) Pub. Date: Sep. 25, 2003

(54) Electronic device design-aiding apparatus, electronic device design-aiding method, electronic device manufacturing method, and computer readable medium storing program

(76) Inventor: Yasuo Furukawa, Tokyo (JP)

Correspondence Address: ROSENTHAL & OSHA L.L.P., 1221 MCKINNEY AVENUE, SUITE 2800, HOUSTON, TX, 77010, US

(21) Appl. No.: 10/414,789

(22) Filed: Apr. 16, 2003

Related U.S. Application Data
(63) Continuation of application No. PCT/JP01/08964, filed on Oct. 11, 2001.

(30) Foreign Application Priority Data
Oct. 18, 2000 (JP) 2000-318460

(51) Int. Cl. G06F 17/50

(52) U.S. Cl. 703/15

(57) ABSTRACT

During designing an electronic device, a test method and a peripheral circuit are also designed using logic data for simulating the operation of the electronic device and the characteristics of a test apparatus used for testing an electronic device. By using the designed test method and logic data representing the operation of the designed peripheral circuit, simulation to judge whether or not the electronic device can be tested. According to the results of the simulation, the designs of the electronic device, the test method, and the peripheral circuit are altered. To optimize the designs of the electronic device, the test method, and the peripheral circuit, simulation is repeated.

The present application is a continuation application of PCT/JP01/08964 filed on Oct. 11, 2001, claiming priority from a Japanese patent application No. 2000-318460 filed on Oct. 18, 2000, the contents of which are incorporated herein by reference.

### BACKGROUND OF THE INVENTION

1. Field of the Invention

The present invention relates to a design-aiding apparatus and a design-aiding method of electronic devices, an electronic device manufacturing method, and a computer readable medium storing program. More particularly, the present invention relates to a system aiding a development of testing electronic devices.

2. Description of the Related Art

In recent years, since functions of electronic devices have been very intricate and highly developed, testing and designing process steps of the electronic devices has been increasing. For this reason, since the proportion of the cost of back-end test to the total cost of the electronic devices has been increasing, it has been required to reduce the test related cost.

However, in a conventional test development, it has been required to prepare a test method according to uses of the electronic devices. Therefore, it has been required to develop a different peripheral circuit and a new measurement unit when a new device is developed. Therefore, the conventional development for the testing has been done according to the process shown in FIG. 1.

The development of testing shown in FIG. 1 is done after a sample of the electronic device is manufactured, and both the electronic device and the test method have to be corrected depending on the result of the test of the sample. Since the electronic device is corrected after the sample of the electronic device is manufactured, the efficiency of the development of the testing is very low. The conventional development of the testing will be explained hereinafter using FIG. 1.

FIG. 1 is a flow chart illustrating the conventional electronic device designing and the conventional development of the testing. First, a concept of the electronic device is designed (S300). Here, an outline of the electronic device based on such as the use of the electronic device is designed. For example, the maximum voltage of input and output, and the outline of input-and-output frequency are designed. Next, an electronic device system is designed (S302). For example, functional block of the electronic device is designed in this step. Next, precise design of circuit of the electronic device is done (S304). Here, the circuit is designed in detail based on the functional block designed in S302. Next, verification of the designed circuit is done (S306). Here, simulation of operation of the designed circuit is performed and the circuit is optimized based on the result of the simulation.

Next, the electronic device including the optimized circuit is formed on a wafer (S310). Next, requirements of the test of the electronic device is determined based on such as input output behavioral characteristics of the formed electronic device. (S312). For example, an input characteristic of the test pattern during the test is determined which is required based on the input output behavioral characteristics of the electronic device or the like. Next, a test plan is drawn up based on the test requirements (S314). Here, a test program or the like is created. Next, an engineering sample (ES), which is a trial production before mass production formed in the wafer process (S308), is verified by the test created in S314 (S316). The result of the verification is fed back to S304, S308, S312, and S314, and optimization of the electronic device and the test is performed. Alternatively, the verification result is fed back to S302. After the optimization of the electronic device and the test, the electronic device is put into commercial production (S318).

In the conventional electronic device designing and the development of the testing explained in reference with FIG. 1, the development of testing is done after an electronic device is formed on a wafer, and the verification is done based on the electronic device and the test development. Moreover, since the contents of the designing of the electronic device or the test are changed based on the verification result, it is time and cost consuming.

### SUMMARY OF THE INVENTION

Accordingly, it is an object of the present invention to provide an electronic device design-aiding apparatus, an electronic device design-aiding method, an electronic device manufacturing method, and a computer readable medium storing program for performing the test design of the electronic device at the time of designing of the electronic device, and performing the test development efficiently. The object can be achieved by combinations described in the independent claims. The dependent claims define further advantageous and exemplary combinations of the present invention.

In order to solve the foregoing problem, according to the first aspect of the present invention, there is provided a design-aiding apparatus for supporting designing of an electronic device. The design-aiding apparatus includes a means for inputting device logic data for simulating operation of the electronic device, and storing the device logic data; an electronic device simulating means for simulating operation of the electronic device based on the device logic data; a test pattern creating means for creating data of test pattern which is creatable by a test apparatus which is to be used to test the electronic device; a peripheral circuit simulating means for simulating operation of a circuit pattern of a peripheral circuit, which is to be prepared between the test apparatus and the electronic device, based on difference between a test pattern required for a test of the electronic device, and a test pattern which is creatable by the test apparatus; and an output means for causing the electronic device simulating means to output a result of the operation by supplying a test pattern created by the test pattern creating means to the peripheral circuit simulating means, and supplying the data, which is simulated and output by/from the peripheral circuit simulating means, to the electronic device simulating means.

In the first aspect, the design-aiding apparatus may further include: a comparison means for comparing the result of operation output by the output means with an expected value which the electronic device is to output based on the test pattern required for a test of the electronic device; and a means for altering at least one of the device logic data, the test pattern created by the test pattern creating means, and the circuit patterns of the peripheral circuit based on the comparison result by the comparison means. Moreover, it is preferable that the design-aiding apparatus further includes a peripheral circuit database for storing a plurality of peripheral circuit logic data for simulating operation of a circuit pattern of the peripheral circuit, and the peripheral circuit simulating means selects the peripheral circuit logic data for a required peripheral circuit from the peripheral circuit database based on a difference between a test pattern required for a test of the electronic device and a test pattern creatable by the test apparatus.

The design-aiding apparatus may further include a means for outputting the peripheral circuit logic data of the peripheral circuit and the device logic data of the electronic device when at least a part of the peripheral circuit, which is selected by the peripheral circuit simulating means, is provided on the same semiconductor substrate as the electronic device. Moreover, the design-aiding apparatus may further include a means for outputting design data of a substrate required to realize at least a part of a circuit pattern of the peripheral circuit selected by the peripheral circuit simulating means. When the device logic data is altered based on the comparison result and the comparison result based on the altered device logic data is a predetermined result, the design-aiding apparatus further includes a means for outputting circuitry data of the electronic device based on the altered device logic data. The design-aiding apparatus may further include a means for outputting pattern data required in order to create the test pattern when the comparison result is the predetermined value.

According to the second aspect of the present invention, there is provided a design-aiding method for supporting designing of an electronic device. The design-aiding method includes steps of: inputting device logic data for simulating operation of the electronic device, and storing the device logic data; simulating operation of the electronic device based on the device logic data; creating data of test pattern which is creatable by a test apparatus which is to be used to test the electronic device; simulating operation of a circuit pattern of a peripheral circuit, which is to be prepared between the test apparatus and the electronic device, based on difference between a test pattern required for a test of the electronic device, and a test pattern which is creatable by the test apparatus; and causing the electronic device simulating step to output a result of the operation by supplying a test pattern created by the test pattern creating step to the peripheral circuit simulating step, and supplying the data, which is simulated and output by/from the peripheral circuit simulating step, to the electronic device simulating step. In the second aspect, it is preferable that the design-aiding method further includes steps of: comparing the result of operation output by the output step with an expected value which the electronic device is to output based on the test pattern required for a test of the electronic device; and altering at least one of the device logic data, the test pattern created by the test pattern creating step, and the circuit patterns of the peripheral circuit based on the comparison result by the comparison step. Moreover, in the peripheral circuit simulating step, it is preferable that peripheral circuit logic data of a required peripheral circuit is selected from a peripheral circuit database which stores a plurality of circuit patterns of the peripheral circuit, based on a difference between a test pattern required for a test of the electronic device, and a test pattern creatable by the test apparatus.

According to the third aspect of the present invention, there is provided an electronic device manufacturing method. The electronic device manufacturing method includes steps of: inputting device logic data for simulating operation of the electronic device, and storing the device logic data; simulating operation of the electronic device based on the device logic data; creating data of test pattern which is creatable by a test apparatus which is to be used to test the electronic device; simulating operation of a circuit pattern of a peripheral circuit, which is to be prepared between the test apparatus and the electronic device, based on difference between a test pattern required for a test of the electronic device, and a test pattern which is creatable by the test apparatus; causing the electronic device simulating step to output a result of the operation by supplying a test pattern created by the test pattern creating step to the peripheral circuit simulating step, and supplying the data, which is simulated and output by/from the peripheral circuit simulating step, to the electronic device simulating step; and comparing the result of operation output by the output step with an expected value which the electronic device is to output based on the test pattern required for a test of the electronic device. The electronic device manufacturing method further includes: a means for altering at least one of the device logic data, and the circuit patterns of the peripheral circuit based on the comparison result by the comparison step; and a means for manufacturing the electronic device based on the altered device logic data and the circuit pattern of the peripheral circuit.

This summary of invention does not necessarily describe all necessary features so that the invention may also be a sub-combination of these described features.

### BRIEF DESCRIPTION OF THE DRAWINGS

FIG. 1 is a flow chart showing a conventional electronic device designing and a test development.

FIG. 2 is a flow chart showing an electronic device designing and a test development according to the present invention.

FIG. 3 is a block diagram exemplary showing a configuration of the electronic device design-aiding apparatus used for a test development flow.

FIG. 4 is a block diagram exemplary showing another configuration of the electronic device design-aiding apparatus according to the present invention.

FIG. 5 is a block diagram exemplary showing a configuration of a computer which functions as a design-aiding apparatus.

FIG. 6 is a flowchart exemplary showing an electronic device design-aiding method according to the present invention.

FIG. 7 is a flowchart exemplary showing an electronic device manufacturing method according to the present invention.

### DETAILED DESCRIPTION OF THE INVENTION

The invention will now be described based on the embodiments hereinafter, which do not intend to limit the scope of the present invention as defined in the appended claims. All of the features and the combinations thereof described in the embodiments are not necessarily essential to the invention.

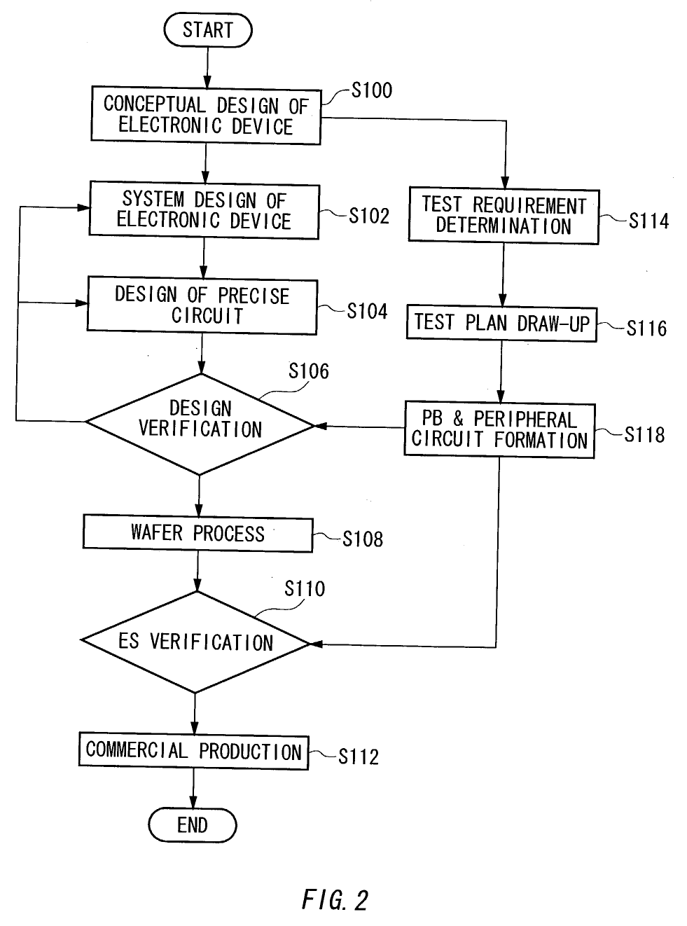

FIG. 2 is a flowchart showing an electronic device designing and a test development according to the present invention. In the present invention, the test development is performed at the time of designing of the electronic device, and process steps of the electronic device designing and the test development is reduced. First, an outline of the electronic device is determined (S100). For example, the outline of such as an input output behavioral characteristics of the electronic device based on such as the use of the electronic device are determined. Next, test requirements of the electronic device are determined based on the determined outline of the electronic device (S114). For example, an input output behavioral characteristic of the electronic device, an outline of the test which is required based on the use, an input characteristic during the test and the like are determined. Next, a test plan is drawn up (S116). In this step, a test program is designed. Next, a performance board (PB) and a peripheral circuit are formed for realizing the drawn-up test plan (S118).

Moreover, a system of the electronic device is designed based on the outline of the electronic device determined in S100 (S102). For example, a functional block of the electronic device is designed in this step. Next, a precise design of a circuit for realizing the designed system is done (S104). Designing verification of the electronic device is done using the circuit which is designed precisely in S104, and the PB and the peripheral circuit which are formed in S118 (S106). A simulation of the operation of the circuit is performed using the circuit, the PB and the peripheral circuit. Result of the simulation is fedback to S104, and performs optimization of the circuit.

Next, the electronic device which includes the optimized circuit is formed on a wafer (S108). The electronic device which includes the precisely designed circuit is formed on the wafer by electron beam exposure or the like, and an engineering sample (ES) is created. The ES is verified using the created ES itself, the PB, and the peripheral circuit (S112). In S112, a working or performance test of the electronic device, which is created as the ES, is done. The result of the performance test is fed back to the wafer process (S108), and the wafer process is optimized. Finally, the electronic device formed by the optimized wafer process is put into commercial production (S112), and the designing and the test development of the electronic device are completed. According to the electronic device designing method and the test development flow explained in this example, the electronic device and the test of the electronic device are optimized before manufacturing the electronic device in the wafer process. Therefore, such as cost and time for the designing and the test development of the electronic device are reduced. A sequence of the test development (S114-S118) will be explained in detail later.

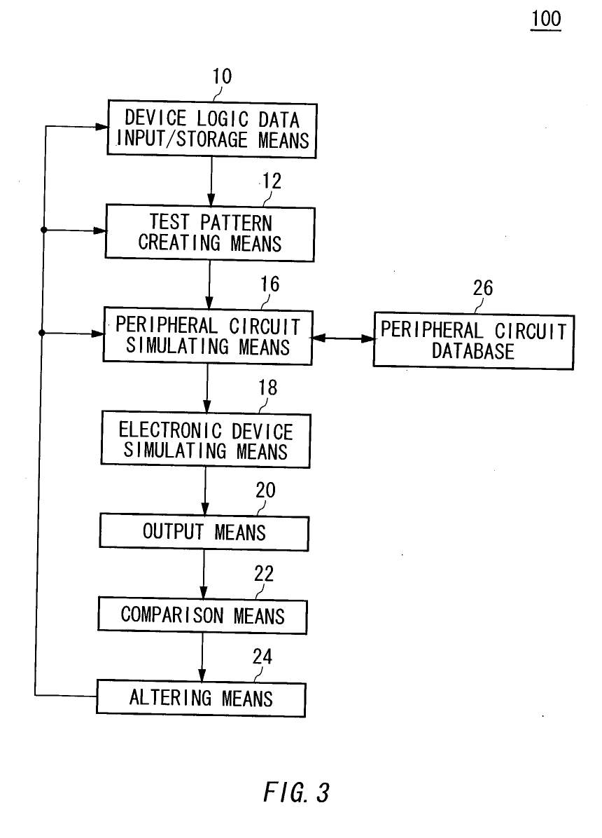

FIG. 3 is a block diagram exemplary showing a configuration of an electronic device design-aiding apparatus 100 used for a test development flow. The electronic device design-aiding apparatus 100 includes a device logic data input/storage means 10 for simulating the operation of the electronic device, a test pattern creating means 12 for creating data of a test pattern, which can be created by a test apparatus which is to be used for the test of the electronic device, a peripheral circuit simulating means 16 for simulating operation of the circuit pattern of the peripheral circuit, which is to be positioned between the test apparatus and the electronic device based on the difference between a test pattern required for the test of the electronic device, and a test pattern which can be created by the test apparatus, a peripheral circuit database 26 for storing a plurality of peripheral circuit logic data for simulating the operation of the circuit pattern of the peripheral circuit, an electronic device simulating means 18 for simulating operation of the electronic device based on device logic data, an output means 20 for inputting the result output from the peripheral circuit simulating means 16 into the electronic device simulating means 18, and outputting the simulating result from the electronic device simulating means, a comparison means 22 for comparing the result output from the output means 20 with a predetermined expected value, and an altering means 24 for altering at least one of the device logic data, the test pattern, and the circuit pattern of the peripheral circuit based on the comparison result.

Generally, the test apparatus which is to be used to test the electronic device has a performance limit, and the test pattern to be created is limited by the performance limit. The test pattern creating means 12 creates the test pattern with taking into consideration of the performance limit of the test apparatus. Moreover, the peripheral circuit is provided in order to complement the difference between the test pattern required for the test of the electronic device, and a test pattern which is created by the test pattern creating means 12.

All or a part of the peripheral circuit may be provided on a same semiconductor substrate as the semiconductor substrate on which the electronic device is formed. Generally, the peripheral circuit provided on the same semiconductor substrate as the electronic device is called Built Off Self Test (BOST). The test pattern created by the test pattern creating means 12 is input into the peripheral circuit simulating means 16, and it simulates the operation of the peripheral circuit and the BOST based on the test pattern. The peripheral circuit simulating means 16 selects the optimal peripheral circuit logic data from the peripheral circuit database based on the difference between the test pattern required for the test of the electronic device, and the test pattern which is created by the test pattern creating means 12, and simulates the operation of the peripheral circuit and the BOST based on the selected peripheral circuit logic data.

That is, the peripheral circuit simulating means 16 selects the optimal peripheral circuit, and simulates the operation of the peripheral circuit when the test pattern, which is created by the test pattern creating means 12, is input into the selected peripheral circuit.

The simulating result by the peripheral circuit simulating means 16 is input into the electronic device simulating means 18, ant it simulates the operation of the electronic device based on the device logic data. That is, the electronic device simulating means 18 simulates the operation of the electronic device when the output result of the peripheral circuit simulated by the peripheral circuit simulating means 16 is input into the electronic device indicated in the device logic data.

The output means 20 outputs the simulating result by the electronic device simulating means 18. That is, the output means 20 operates the electronic device simulating means 18, and causes the electronic device simulating means 18 to output the result of the operation of the electronic device based on the device logic data by supplying the test pattern created by the test pattern creating means 12 to the peripheral circuit simulating means 16, and supplying the data, which is simulated and output by/from the peripheral circuit simulating means 16, to the electronic device simulating means 18.

The comparison means 22 compares the result of the operation output from the output means 20 with an expected value which the electronic device is to output based on the test pattern required for the test of the electronic device. That is, the comparison means 22 inputs the test pattern created by the test pattern creating means 12 into the peripheral circuit, and judges whether the output result of the electronic device when the output from the peripheral circuit is input into the electronic device is the expected value or not. It is preferable that the expected value is created by the test pattern creating means 12 based on the created test pattern.

The altering means 24 alters at least one of the device logic data, the test pattern created by the test pattern creating means 12, and the circuit pattern of the peripheral circuit based on the comparison result by the comparison means 22. If at least one of the device logic data, the test pattern created by the test pattern creating means 12, and the circuit pattern of the peripheral circuit is altered, the altering means 24 supplies the data for altering to at least one of the device logic data input/storage means 10, the test pattern creating means 12, and the peripheral circuit simulating means 16, and the device logic data input/storage means 10, the test pattern creating means 12, and the peripheral circuit simulating means 16 respectively alter the device logic data, the test pattern, and the circuit pattern of the peripheral circuit, which are to be altered.

In this case, the peripheral circuit simulating means 16 selects from the peripheral circuit database 26 the peripheral circuit logic data corresponding to the circuit pattern of the peripheral circuit which is to be altered. Alternatively, if there is no peripheral circuit logic data corresponding to the circuit pattern of the peripheral circuit which is to be altered in the peripheral circuit database 26, the electronic device design-aiding apparatus 100 further includes a peripheral circuit logic data creating means for creating the peripheral circuit logic data and storing it in the peripheral circuit database.

Alternatively, the electronic device design-aiding apparatus 100 further includes a means for outputting the peripheral circuit logic data of the peripheral circuit and the device logic data of the electronic device when at least a part of the peripheral circuit, which is selected by the peripheral circuit simulating means 16, is provided on the same semiconductor substrate as the electronic device. That is, the electronic device design-aiding apparatus 100 further includes the means for outputting the device logic data of the electronic device including the BOST, and the peripheral circuit logic data of the peripheral circuit.

Alternatively, it further includes a means for outputting the design data of the substrate required in order to realize at least a part of the circuit pattern of the peripheral circuit selected by the peripheral circuit simulating means 16.

Alternatively, if the device logic data is altered based on the comparison result by the comparison means 22, and the comparison result based on the altered device logic data is a predetermined result, it further includes a means for outputting a circuitry data of the electronic device based on the altered device logic data. That is, the means for outputting the circuitry data outputs the circuitry data of the optimized electronic device.

Alternatively, it further includes a means for outputting a pattern data required for creating the test pattern in the case that the comparison result by the comparison means 22 being the predetermined result. That is, the means for outputting the pattern data outputs the optimized test pattern.

According to the above-mentioned electronic device design-aiding apparatus 100, the test development is performed before forming the electronic device on a wafer by the simulation using the device logic data based on the outline of the electronic device. Therefore, it is possible to optimize the device logic data which indicates the electronic device, the peripheral circuit logic data which indicates the peripheral circuit, and the test pattern before the manufacture of the electronic device, and it is possible to reduce the process steps of the designing and test development of the electronic device.

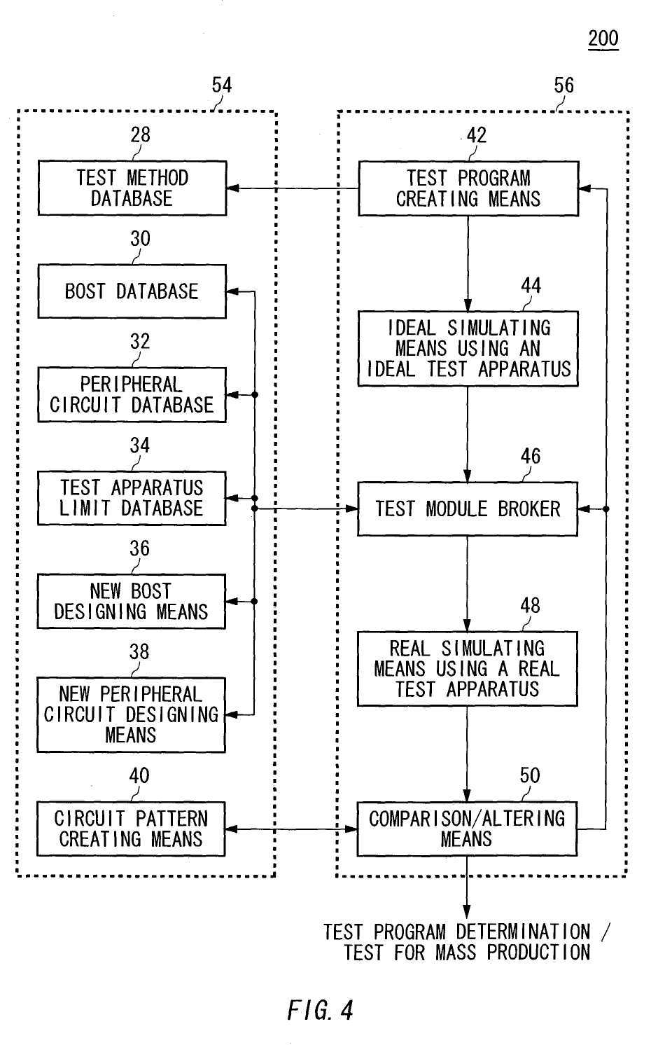

FIG. 4 is a block diagram exemplary showing another configuration of the electronic device design-aiding apparatus according to the present invention. The electronic device design-aiding apparatus 200 includes a database unit 54 and a simulating unit 56. The database unit 54 includes a test method database 28, a BOST database 30, a peripheral circuit database 32, a test apparatus limit database 34, a new BOST designing means 36, a new peripheral circuit designing means 38, and a circuit pattern creating means 40.

The test method database 28 stores a test pattern, a calculation method of the data and the like. The BOST database 30 stores a plurality of logic data of the BOST. The peripheral circuit database 32 stores a plurality of logic data of the peripheral circuit. The test apparatus limit database 34 stores performance limits of the test apparatuses which are to be used for the test of the electronic device, each for a different kind of the test apparatuses. The new BOST designing means 36 creates logic data of the BOST which is not stored in the BOST database 30. The new peripheral circuit designing means 38 creates logic data of the peripheral circuit which is not stored in the peripheral circuit database 32. The circuit pattern creating means 40 creates logic data of the electronic device.

Alternatively, the BOST logic data and the peripheral circuit logic data created by the new BOST designing means 36 and the new peripheral circuit designing means 38 are stored in the BOST database 30 and the peripheral circuit database 32.

Alternatively, the BOST database 30 and the peripheral circuit database 32 include similar function and configuration to that of the peripheral circuit database 26 explained in reference with FIG. 3.

The simulating unit 56 includes a test program creating means 42, an ideal simulating means 44 using an ideal test apparatus, a test module broker 46, a real simulating means 48 using a real test apparatus, and a comparison/altering means 50. Based on the outline of the electronic device, the test program creating means 42 selects a test pattern, a calculation method of measurement data and the like from the test method database, and creates a test program incorporating the test pattern and the calculation method.

The ideal simulating means 44 using the ideal test apparatus performs the simulation without taking into consideration the performance limit of the test apparatus which is to be used for test of the electronic device. For example, the simulation is performed on the assumption that unlimited number of signal generators and measuring instruments are available that can handle infinite frequency, voltage and current, and the measuring instruments can be connected to any points of measurement. The ideal simulating means 44 using the ideal test apparatus verifies the test pattern, the calculation method and the like based on the simulation result, and optimizes the test pattern, the calculation method and the like. Alternatively, the ideal simulating means 44 using an ideal test apparatus includes the same or similar function and configuration as/to that of the test pattern creating means 12 explained in reference with FIG. 3.

The test module broker 46 reads the performance limit of the test apparatus used for the test of the electronic device from the test apparatus limit database, and selects the peripheral circuit logic data and the BOST logic data of the peripheral circuit and the BOST for complementing the performance limit from the peripheral circuit database 32 and the BOST database 30. If the logic data of the peripheral circuit and the BOST for complementing the performance limit is not stored in the peripheral circuit database 32 and the BOST database 30, the new peripheral circuit designing means 38 and the new BOST designing means 36 create a logic data of the peripheral circuit and the BOST for complementing the performance limit and supply them to the test module broker 46.

Alternatively, the logic data of the peripheral circuit and the BOST created by the new peripheral circuit designing means 38 and the new BOST designing means 36 are stored in the peripheral circuit database 32 and the BOST database 30. Alternatively, the test module broker 46 includes the same or similar function and configuration as/to that of the peripheral circuit simulating means explained in reference with FIG. 3.

The real simulating means 48 using the real test apparatus performs the simulation with taking into consideration of the performance limit of the test apparatus which is to be used for the test of the electronic device. That is, the test simulation of the electronic device is performed based on the logic data of the BOST and the peripheral circuit, which are selected by the test module broker 46 with taking into consideration of the performance limit of the test apparatus, the logic data of the electronic device, and the test program created by the test program creating means. Alternatively, the real simulating means 48 using the real test apparatus includes the same or similar function and configuration as/to that of the peripheral circuit simulating means 16 and the electronic device simulating means 18 explained in reference with FIG. 3.

The comparison/altering means 50 alters the test pattern, the calculation method, the logic data of the peripheral circuit, the logic data of the BOST, and the logic data of the electronic device based on the simulation result by the real simulating means 48 using the real test apparatus. Based on the altered test pattern, the calculation method, the logic data of the peripheral circuit, the logic data of the BOST, and the logic data of the electronic device, the test program creating means 42 newly creates a test program, and the test module broker 46 selects the logic data of the BOST and the peripheral circuit. Moreover, the circuit pattern creating means 40 creates the circuit pattern of the electronic device based on the logic data of the altered electronic device. According to the above-explained electronic device design-aiding apparatus 200, the problem during the test, which is caused when the performance limit of the test apparatus is taken into consideration before manufacturing the electronic device, is solved by altering the test pattern, the test method such as the calculation method, and the logic data which indicates the peripheral circuit, the BOST, and the circuit pattern of the electronic device. Then it is possible to optimize the test pattern, the test method such as the calculation method, and the logic data which indicates the peripheral circuit, the BOST, and the circuit pattern of the electronic device.

Alternatively, the database unit 54 and the simulating unit 56 send and receive information through a network. For example, a manufacturer of the test apparatus provides the database 54 on the Internet to supply the simulating unit 56 to a user. In one example, the simulating unit 56 is a program, or a computer which is operated by the program. Alternatively, it is a record medium which stores the program.

The program causes the computer to function as the simulating unit 56. That is, the program causes the computer to function as the test program creating means 42, the ideal simulating means 44 using the ideal test apparatus, the test module broker 46, the real simulating means 48 using the real test apparatus, and the comparison/altering means 50.

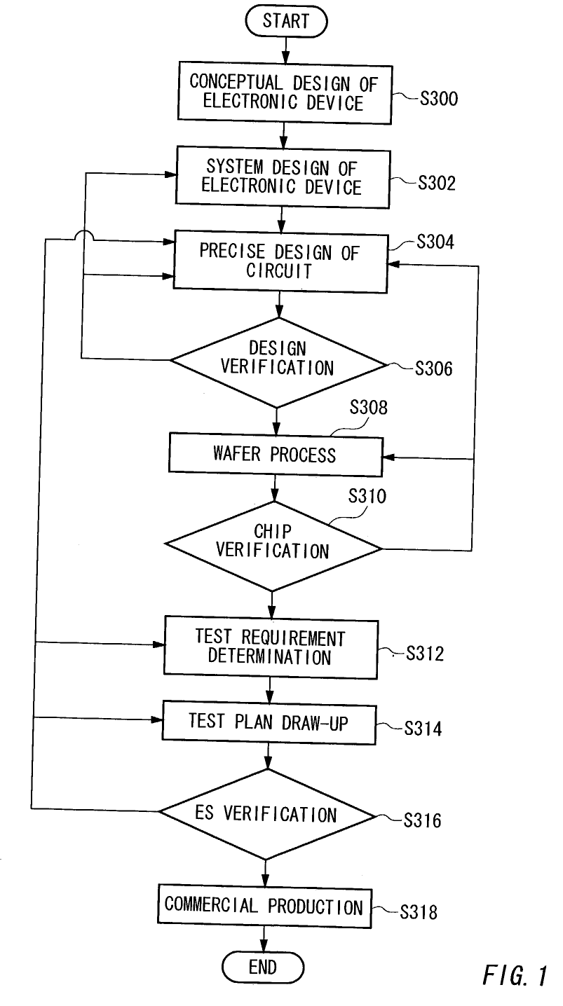

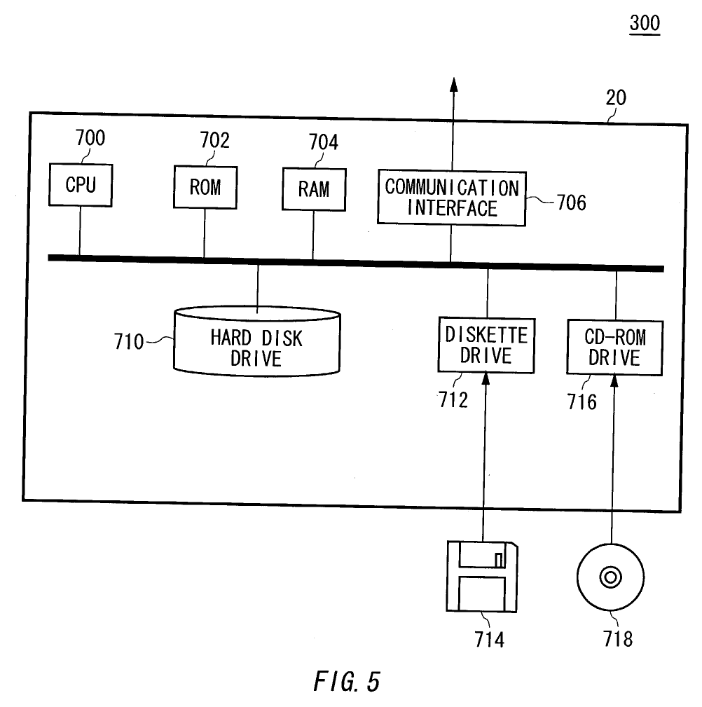

FIG. 5 is a block diagram exemplary showing a configuration of a computer 300 which functions as the simulating unit 56. The computer 300 includes CPU 700, ROM 702, RAM 704, a communication interface 706, a hard disk drive 710, a diskette drive 712, and a CD-ROM drive 716. The CPU 700 operates based on the program stored in the ROM 702, the RAM 704, the hard disk 710, a diskette 714, and a CD-ROM 718. The communication interface 706 communicates with the database unit 54 through the Internet or the like. The hard disk drive 710, as an example of a storing device, stores setting information of the computer 300 and the program by which the CPU 700 of the computer 300 is executed. The ROM 702, the RAM 704, and/or the hard disk drive 710 store the simulation program which causes the computer 300 to function as the simulating unit 56 which explained in reference with FIGS. 1-4.

The diskette drive 712 reads the data or the program in the diskette 714, and provides it to the CPU 700. The CD-ROM drive 716 reads the data or the program in the CD-ROM 718, and provides it to the CPU 700. The communication interface 706 connects with the Internet 10, and transmits and receives the data.

The software executed by the CPU 700 is provided for a user stored in the record medium such as the diskette 714 or the CD-ROM 718. The software stored in the record medium is either compressed or decompressed. The software is installed in the hard disk drive 710 from the record medium, read by the RAM 704, and executed by the CPU 700.

The simulation program causes the computer 300 to function as the test program creating means 42, the ideal simulating means 44 using the ideal test apparatus, the test module broker 46, the real simulating means 48 using the real test apparatus, and the comparison/altering means 50, all of which are explained in reference with FIGS. 1-4.

For example, the simulation program is stored in the ROM 702, the RAM 704, the hard disk drive 710, the diskette 714, and/or the CD-ROM 718, and the CPU 700 performs calculation for causing the computer 300 to function as the simulating unit 56. Moreover, the communication interface 706 transmits and receives the required data to/from the database unit 54 which is located outside.

The simulation program is directly read from the record medium by the RAM 704 and executed, or it is installed in the hard disk drive 710 once and then it is read by the RAM 704 and executed. Furthermore, the simulation program is stored in a single record medium, or a plurality of record media. Alternatively, the simulation program stored in the record medium provides each function in cooperation with an operating system. For example, the simulation program requests the operating system to do some or all functions, or the function is provided based on the response from the operating system.

It is possible to use an optical record medium such as DVD or PD, a magneto-optical record medium such as Minidisk, a tape medium, a magnetic record medium or a semiconductor memory such as an IC card or a Miniature Card as a record medium for storing the simulation program instead of the diskette or the CD-ROM. A storage device, such as a hard disk or RAM in a server system on a dedicated communication network or the Internet, may be used as a record medium.

Alternatively, the simulation program causes the computer 300 to function as the electronic device design-aiding apparatus 100 which is explained in reference with FIG. 3. That is, the simulation program causes the computer 300 to function as the device logic data input/storage means 10, the test pattern creating means 12, the peripheral circuit simulating means 16, the electronic device simulating means 18, the output means 20, the comparison means 22, and the altering means 24.

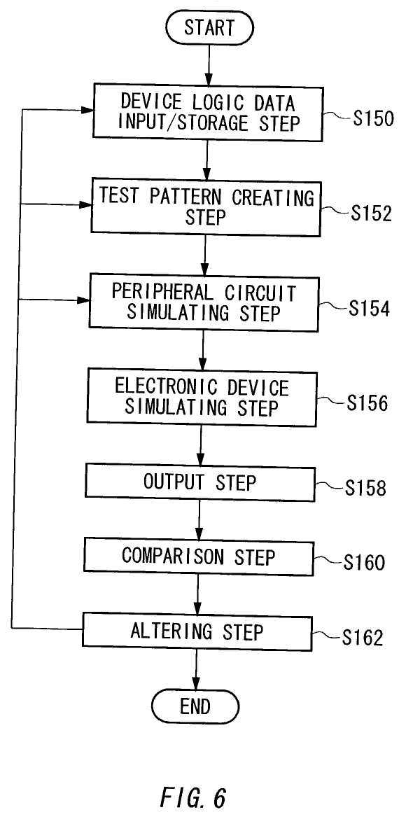

FIG. 6 is a flowchart exemplary showing the electronic device design-aiding method according to the present invention. First, the device logic data, which simulates the operation of the electronic device in a device logic data input/storage step, is input and stored (S150). In a test pattern creating step, the test pattern with taking into consideration of the performance limit of the test apparatus is created (S152). Alternatively, in the test pattern creating step, the test pattern is created using the test pattern creating means 12 explained in reference with FIG. 3, or the test program creating means 42 explained in reference with FIG. 4.

In a peripheral circuit simulating step, the test pattern created in the test pattern creating step is input, and the operations of the peripheral circuit and the BOST are simulated based on the test pattern (S154). In the peripheral circuit simulating step, the optimal peripheral circuit logic data is selected from the peripheral circuit database based on the difference between the test pattern required for the test of the electronic device and the test pattern created by the test pattern creating step, and the operation of the peripheral circuit and the BOST are simulated based on the selected peripheral circuit logic data.

That is, in the peripheral circuit simulating step, the operation of the peripheral circuit is simulated when the optimal peripheral circuit is selected and the test pattern created in the test pattern creating step is input into the selected peripheral circuit. Alternatively, in the peripheral circuit simulating step, the operation of the peripheral circuit and the BOST are simulated using the peripheral circuit simulating means explained in reference with FIG. 3, or using the real simulating means 48 which uses the real test apparatus explained in reference with FIG. 4.

In an electronic device simulating step, the simulation result of the peripheral circuit simulation step is input, and the operation of the electronic device is simulated based on the device logic data (S156). That is, in the electronic device simulating step, the operation of the electronic device is simulated when the output result of peripheral circuit, which is simulated in the peripheral circuit simulation step, is input into the electronic device indicated in the device logic data. Alternatively, in the electronic device simulating step, the operation of the electronic device is simulated using the electronic device simulating means 18 explained in reference with FIG. 3, or the real simulating means 48 using the real test apparatus explained in reference with FIG. 4.

In an output step, the simulating result in the electronic device simulating step is output (S158). That is, in the output step, the electronic device simulating step is caused to operate and output the result of the operation by supplying the test pattern created in the test pattern creating step to the peripheral circuit simulating step, and further supplying the data, which is simulated and output in/from the peripheral circuit simulating step, to the electronic device simulating step. Alternatively, in the output step, the simulation result is output using the output means 20 explained in reference with FIG. 3.

In a comparison step, the result of the operation output in the output step is compared with the expected value which the electronic device is to output based on the test pattern required for the test of the electronic device (S160). That is, in the comparison step, it is judged whether the output result of the electronic device when the test pattern created in the test pattern creating step is input into the peripheral circuit, and the output of the peripheral circuit is input into the electronic device, is an expected value. The expected value is created based on the test pattern created in the test pattern creating step. In the comparison step, the result of the operation output in the output step is compared with the expected value using the comparison means 22 explained in reference with FIG. 3, or the comparison/change step explained in reference with FIG. 4.

In an altering step, at least one of the device logic data, the test pattern created in the test pattern creating step, and the circuit pattern of the peripheral circuit is altered based on the comparison result in the comparison step (S162). The altering step 24 supplies the data for the alteration to at least one of the device logic data input/storage step, the test pattern creating step, and the peripheral circuit simulating step, in cases where at least one of the device logic data, the test pattern created in the test pattern creating step, and the circuit patterns of the peripheral circuit is altered. In the device logic data input/storage step, the test pattern creating step, and the peripheral circuit simulating step, the device logic data, the test pattern, and the circuit pattern of the peripheral circuit, which are to be altered, are altered respectively. In this case, in the peripheral circuit simulating step, the peripheral circuit logic data, which corresponds to the circuit pattern of the peripheral circuit which is to be altered, is selected from the peripheral circuit database which stores a plurality of peripheral circuit logic data.

Moreover, in cases where there is no peripheral circuit logic data corresponding to the circuit pattern of the peripheral circuit which is to be altered in the peripheral circuit database, there may be a peripheral circuit logic data creating step, in which the peripheral circuit logic data is created and stored it in the peripheral circuit database.

Alternatively, in the altering step, at least one of the device logic data, the test pattern created in the test pattern creating step, and the circuit patterns of the peripheral circuit is altered using the altering means 24 explained in reference with FIG. 3, or the comparison/altering means 50 explained in reference with FIG. 4.

Alternatively, the electronic device design-aiding method further includes a step of outputting the peripheral circuit logic data of the peripheral circuit and the device logic data of the electronic device when at least a part of the peripheral circuit, which is selected in the peripheral circuit simulating step, is provided on the same semiconductor substrate as the electronic device. That is, the electronic device design-aiding method further includes the step of outputting the device logic data of the electronic device including the BOST, and the peripheral circuit logic data of the peripheral circuit.

Alternatively, the electronic device design-aiding method further includes a step of outputting the design data of the substrate required in order to realize at least apart of the circuit pattern of the peripheral circuit selected in the peripheral circuit simulating step.

Alternatively, the electronic device design-aiding method further includes a step of outputting the circuitry data of the electronic device based on the altered device logic data, in cases where the device logic data is altered based on the comparison result in the comparison step and the comparison result based on the altered device logic data is a predetermined result. That is, the electronic device design-aiding method further includes a step of outputting the circuitry data of the optimized electronic device.

Alternatively, the electronic device design-aiding method further includes a step of outputting the pattern data which is required to create the test pattern when the comparison result in the comparison step is the predetermined result. That is, the electronic device design-aiding method further includes a step of outputting the optimized test pattern.

Alternatively, the electronic device design-aiding method further includes a step of outputting the pattern data required in order to create the test pattern when the comparison result in the comparison step is a predetermined result. That is, the electronic device design-aiding method further includes a step of outputting the optimized test pattern.

According to the above-described electronic device design-aiding method, the test development is done before the manufacture of the electronic device by carrying out the simulation using the device logic data based on the outline of the electronic device. Therefore, it is possible to optimize the device logic data indicating the electronic device, the peripheral circuit logic data indicating the peripheral circuit, and the test pattern before the manufacture of the electronic device. Consequently, it is possible to reduce the process steps of designing and test development of the electronic device.

Alternatively, the electronic device design-aiding apparatus explained in reference with FIG. 3 or FIG. 4 is used for the electronic device design-aiding method explained in reference with FIG. 6. The following is the explanation where the electronic device design-aiding apparatus explained in reference with FIG. 4 is to be used.

The database unit 54 of the electronic device design-aiding apparatus 200 explained in reference with FIG. 4 is provided on the Internet, and it is controlled by a manufacturer of the test apparatus. Moreover, the manufacturer of the test apparatus supplies the simulating unit 56 to a user of the test apparatus, and the database unit 54 and the simulating unit 56 send and receive information to/from one another through the Internet. The user of the test apparatus performs the test design assuming the ideal test apparatus. At this time, the user of the test apparatus accesses the test method database 28 through the Internet, and creates the test program using the test program creating means 42. Next, the created test program is verified by the simulating means 44 using the ideal test apparatus. Next, the peripheral circuit, the BOST or the like with taking into consideration of the performance limit of the test apparatus which are to be used for the test of the electronic device are selected from the peripheral circuit database and the BOST database using the test module broker 46.

In cases where the suitable logic data of the peripheral circuit and the BOST is not stored in the database, the user of the test apparatus transmits the test program, the performance limit of the test apparatus, and the logic data of the electronic device to the new BOST designing means 36 and the new peripheral circuit designing means 38. Then, the new BOST designing means 36 and the new peripheral circuit designing means 38 design the logic data of the BOST and the peripheral circuit based on the received data, and transmit them to the user of the test apparatus.

Based on the obtained logic data of the BOST and the peripheral circuit, the real simulating means 48 using the real test apparatus performs the simulation. The user of the test apparatus evaluates the obtained simulating result using the comparison/altering means 50, and based on the evaluation result, required alteration of the test pattern and the like are performed. The test pattern and the like are optimized by repeating the alteration until the obtained evaluation result matches the predetermined result.

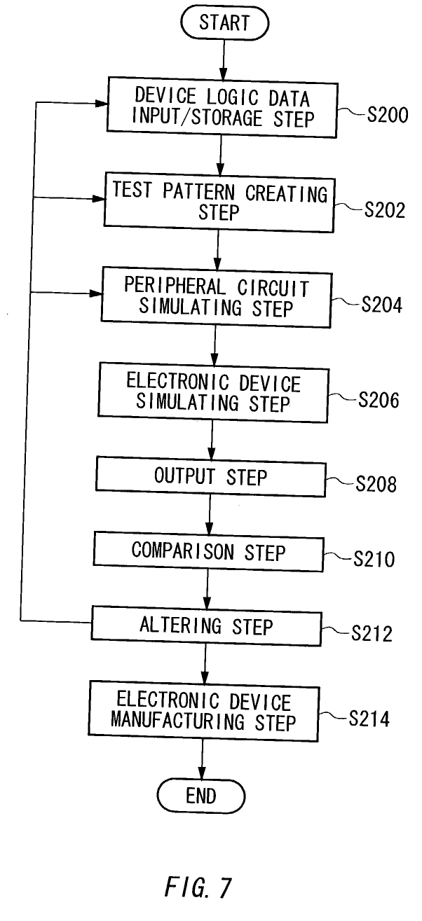

FIG. 7 is a flow chart exemplary showing an electronic device manufacturing method according to the present invention. In this flow chart, since the steps from a device logic data input/storage step (S200) to an altering step (S212) in the present example are the same or similar as/to the steps from the device logic data input/storage step (S100) to the altering step (S112) which are explained in reference with FIG. 5, the explanation of the steps of the present example will be omitted. In an electronic device manufacturing step, the electronic device is manufactured based on the device logic data altered in the altering step (S214). Alternatively, in the electronic device manufacturing step, the circuit pattern of the electronic device is created using the circuit pattern creating means 40 explained in reference with FIG. 4, and the electronic device is manufactured based on the created circuit pattern.

According to the above-described electronic device manufacturing method, the test development is performed at the time of designing of the electronic device, the device logic data indicating the circuit pattern of the electronic device is optimized based on the test simulation at the test development, and the process steps of designing of the electronic device is decreased.

As it is obvious from the foregoing explanation, according to the present invention, the test development is performed at the time of designing of the electronic device. Therefore, the designing process steps of the electronic device, and the test development process steps of the electronic device are decreased.

Although the present invention has been described by way of exemplary embodiment, the scope of the present invention is not limited to the foregoing embodiment. Various modifications in the foregoing embodiment may be made when the present invention defined in the appended claims is enforced. It is obvious from the definition of the appended claims that embodiments with such modifications also belong to the scope of the present invention.

What is claimed is:

1. A design-aiding apparatus for supporting designing of an electronic device, comprising:
a means for inputting device logic data for simulating operation of the electronic device, and storing the device logic data;
an electronic device simulating means for simulating operation of the electronic device based on the device logic data;
a test pattern creating means for creating data of test pattern which is creatable by a test apparatus which is to be used to test the electronic device;
a peripheral circuit simulating means for simulating operation of a circuit pattern of a peripheral circuit, which is to be prepared between the test apparatus and the electronic device, based on difference between a test pattern required for a test of the electronic device, and a test pattern which is creatable by the test apparatus; and
an output means for causing said electronic device simulating means to output a result of the operation by supplying a test pattern created by said test pattern creating means to said peripheral circuit simulating means, and supplying the data, which is simulated and output by/from said peripheral circuit simulating means, to said electronic device simulating means.

2. The design-aiding apparatus as claimed in claim 1, further comprising:
a comparison means for comparing the result of operation output by said output means with an expected value which the electronic device is to output based on the test pattern required for a test of the electronic device; and
a means for altering at least one of the device logic data, the test pattern created by said test pattern creating means, and the circuit patterns of the peripheral circuit based on the comparison result by said comparison means.

3. The design-aiding apparatus as claimed in claim 2, further comprising
a peripheral circuit database for storing a plurality of peripheral circuit logic data for simulating operation of a circuit pattern of the peripheral circuit, and wherein
said peripheral circuit simulating means selects said peripheral circuit logic data for a required peripheral circuit from said peripheral circuit database based on a difference between a test pattern required for a test of the electronic device and a test pattern creatable by the test apparatus.

4. The design-aiding apparatus as claimed in claim 3, further comprising a means for outputting the peripheral circuit logic data of the peripheral circuit and the device logic data of the electronic device when at least a part of the peripheral circuit, which is selected by said peripheral circuit simulating means, is provided on the same semiconductor substrate as the electronic device.

5. The design-aiding apparatus as claimed in claim 3, further comprising a means for outputting design data of a substrate required to realize at least a part of a circuit pattern of the peripheral circuit selected by said peripheral circuit simulating means.

6. The design-aiding apparatus as claimed in claim 4, wherein when the device logic data is altered based on the comparison result and the comparison result based on the altered device logic data is a predetermined result, the design-aiding apparatus further comprises a means for outputting circuitry data of the electronic device based on the altered device logic data.

7. The design-aiding apparatus as claimed in claim 5, wherein when the device logic data is altered based on the comparison result and the comparison result based on the altered device logic data is a predetermined result, the design-aiding apparatus further comprises a means for outputting circuitry data of the electronic device based on the altered device logic data.

8. The design-aiding apparatus as claimed in claim 6, further comprising a means for outputting pattern data required in order to create the test pattern when the comparison result is the predetermined value.

9. The design-aiding apparatus as claimed in claim 7, further comprising a means for outputting pattern data required in order to create the test pattern when the comparison result is the predetermined value.

10. A design-aiding method for supporting designing of an electronic device, comprising steps of:
inputting device logic data for simulating operation of the electronic device, and storing the device logic data;
simulating operation of the electronic device based on the device logic data;
creating data of test pattern which is creatable by a test apparatus which is to be used to test the electronic device;
simulating operation of a circuit pattern of a peripheral circuit, which is to be prepared between the test apparatus and the electronic device, based on difference between a test pattern required for a test of the electronic device, and a test pattern which is creatable by the test apparatus; and
causing said electronic device simulating step to output a result of the operation by supplying a test pattern created by said test pattern creating step to said peripheral circuit simulating step, and supplying the data, which is simulated and output by/from said peripheral circuit simulating step, to said electronic device simulating step.

11. The design-aiding method as claimed in claim 10, further comprising steps of:
comparing the result of operation output by said output step with an expected value which the electronic device is to output based on the test pattern required for a test of the electronic device; and
altering at least one of the device logic data, the test pattern created by said test pattern creating step, and the circuit patterns of the peripheral circuit based on the comparison result by said comparison step.

12. The design-aiding apparatus as claimed in claim 11, wherein, in said peripheral circuit simulating step, peripheral circuit logic data of a required peripheral circuit is selected from a peripheral circuit database which stores a plurality of circuit patterns of said peripheral circuit, based on a difference between a test pattern required for a test of the electronic device, and a test pattern creatable by the test apparatus.

13. An electronic device manufacturing method, comprising steps of:
inputting device logic data for simulating operation of the electronic device, and storing the device logic data;
simulating operation of the electronic device based on the device logic data;
creating data of test pattern which is creatable by a test apparatus which is to be used to test the electronic device;
simulating operation of a circuit pattern of a peripheral circuit, which is to be prepared between the test apparatus and the electronic device, based on difference between a test pattern required for a test of the electronic device, and a test pattern which is creatable by the test apparatus;
causing said electronic device simulating step to output a result of the operation by supplying a test pattern created by said test pattern creating step to said peripheral circuit simulating step, and supplying the data, which is simulated and output by/from said peripheral circuit simulating step, to said electronic device simulating step; and
comparing the result of operation output by said output step with an expected value which the electronic device is to output based on the test pattern required for a test of the electronic device;
wherein the electronic device manufacturing method further comprises:
a means for altering at least one of the device logic data, and the circuit patterns of the peripheral circuit based on the comparison result by said comparison step; and
a means for manufacturing the electronic device based on the altered device logic data and the circuit pattern of the peripheral circuit.

14. A computer readable medium storing thereon a program for causing the computer to function as a design-aiding apparatus which supports designing of an electronic device, the program causes the computer to function as:
a means for inputting device logic data for simulating operation of the electronic device, and storing the device logic data;
an electronic device simulating means for simulating operation of the electronic device based on the device logic data;
a test pattern creating means for creating data of test pattern which is creatable by a test apparatus which is to be used to test the electronic device;
a peripheral circuit simulating means for simulating operation of a circuit pattern of a peripheral circuit, which is to be prepared between the test apparatus and the electronic device, based on difference between a test pattern required for a test of the electronic device, and a test pattern which is creatable by the test apparatus; and
an output means for causing said electronic device simulating means to output a result of the operation by supplying a test pattern created by said test pattern creating means to said peripheral circuit simulating means, and supplying the data, which is simulated and output by/from said peripheral circuit simulating means, to said electronic device simulating means.

15. A design-aiding apparatus for supporting designing of an electronic device using a database provided outside, comprising:
a test program creating means for receiving a test pattern, by which the electronic device is tested, from the database, and creating a test program for the electronic device based on the test pattern;
an ideal simulating means, which uses an ideal test apparatus, for simulating a test of the electronic device, and performing optimization of the test program, assuming a test apparatus is available, which handles a signal having substantially infinite frequency, as a test apparatus which is to be used for a test of the electronic device;
a test module broker for reading data of a peripheral circuit from the database for complementing the test apparatus, based on a performance limit of a test apparatus used for a test of the electronic device and the optimized test program;
a real simulating means, which uses a real test apparatus, for simulating a test of the electronic device, based on a performance limit of a test apparatus used for a test of the electronic device and the optimized test program; and
a comparison/altering means for altering the test program and the data of the peripheral circuit, based on the simulating result of said real simulating means using the real test apparatus.

16. A computer readable medium storing thereon a program for causing the computer to function as a design-aiding apparatus which supports designing of an electronic device using a database located outside, the program causes the computer to function as:
a test program creating means for receiving a test pattern, by which the electronic device is tested, from the database, and creating a test program for the electronic device based on the test pattern;
an ideal simulating means, which uses an ideal test apparatus, for simulating a test of the electronic device, and performing optimization of the test program, assuming a test apparatus is available, which handles a signal having substantially infinite frequency, as a test apparatus which is to be used for a test of the electronic device;
a test module broker for reading data of a peripheral circuit from the database for complementing the test apparatus, based on a performance limit of a test apparatus used for a test of the electronic device and the optimized test program;
a real simulating means, which uses a real test apparatus, for simulating a test of the electronic device, based on a performance limit of a test apparatus used for a test of the electronic device and the optimized test program; and
a comparison/altering means for altering the test program and the data of the peripheral circuit, based on the simulating result of said real simulating means using the real test apparatus.
